(19) United States
(12) Patent Application Publication
(10) Pub. No.: US 2026/0152628 A1
(43) Pub. Date: Jun. 4, 2026

(54) THERMOPLASTIC URETHANES IN RACING TIRE COMPOSITIONS

(71) Applicant: The Goodyear Tire & Rubber Company, Akron, OH (US)

(72) Inventors: Steve Ludwig, Butzbach (DE); Gary Terence Barrett, West Midlands (GB); Anna Katharina Bier, Hanau (DE); Björn Springer, Bruchköbel (DE)

(21) Appl. No.: 18/965,450

(22) Filed: Dec. 2, 2024

(51) Int. Cl. C08L 9/06; B60C 1/00; B60C 11/00

(52) U.S. Cl. CPC C08L 9/06; B60C 1/0016; B60C 11/0008; B60C 2011/0016; B60C 2200/10; C08L 2205/025; C08L 2205/035; C08L 2207/322

(57) ABSTRACT

In one aspect, the disclosure relates a composition, comprising: a concentration of one or more thermoplastic polyurethanes; and at least 75 parts per hundred rubber (phr) of one or more solution-polymerized styrene butadiene rubbers. Also disclosed herein are tires comprising the disclosed compositions. This abstract is intended as a scanning tool for purposes of searching in the particular art and is not intended to be limiting of the present disclosure.

### BACKGROUND

The demand for improved tire performance has resulted in the development and evaluation of new materials that have desirable properties. Improving tire properties such as rolling resistance while maintaining the balance in tradeoffs can be challenging. There is a need for rubber formulations that have a balance between processability, low tire rolling resistance, and good hardness and/or elongation properties. These needs and other needs are satisfied by the present disclosure.

### SUMMARY

In accordance with the purpose(s) of the disclosure, as embodied and broadly described herein, the disclosure, in one aspect, relates to a composition, comprising: a concentration of one or more thermoplastic polyurethanes; and at least 75 parts per hundred rubber (phr) of one or more solution-polymerized styrene butadiene rubbers. Also disclosed herein are tires comprising the disclosed compositions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure.

Moreover, in the drawings, like reference numerals designate corresponding parts throughout the several views.

FIG. 1 shows a schematic partial cross section of a motorcycle tire tread as well as underlying reinforcing reinforced rubber plies, in accordance with a non-limiting embodiment of the present invention.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature.

When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound.

Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a filler,” “an oil,” or “a fatty acid,” includes, but is not limited to, two or more such fillers, oils, or fatty acids, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

The terms “rubber” and “elastomer” may be used herein interchangeably, unless indicated otherwise.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

Unless otherwise specified, temperatures referred to herein are based on atmospheric pressure (i.e. one atmosphere).

### B. Rubber Compositions

In one aspect, the disclosure relates to a composition, such as an uncured or cured rubber composition, comprising: a concentration of one or more thermoplastic polyurethanes; and one or more solution-polymerized styrene butadiene rubbers (SSBRs). More specifically, in one aspect, the present disclosure further relates to a composition, comprising: a concentration of one or more thermoplastic polyurethanes (TPUs); and at least 75 parts per hundred rubber (phr) of one or more solution-polymerized styrene butadiene rubbers. The present disclosure also relates to articles, such as tires and/or components of tires, comprising the compositions. Thermoplastic urethanes (TPUs) are not typically used in conventional rubber compositions used in tire production. They are typically used as dampers in industrial applications or other applications utilizing a polymer formulation having a need for enhanced damping properties. The disclosed rubber compositions comprising TPUs and at least one solution-polymerized styrene butadiene rubber can be used to produce a tire, such as a racing tire, with a relatively high level of dry grip performance and other desirable properties, such as relatively low sensitivity to ambient temperatures and/or better track wear.

The one or more SSBRs can be present in the composition in an amount of at least about 75 phr, at least about 80 phr, at least about 85 phr, at least about 90 phr, at least about 95 phr, or at least about 100 phr. In another aspect, the one or more SSBRs can be present in the composition in an amount of no more than about 75 phr, no more than about 80 phr, no more than 85 phr, no more than 90 phr, no more than about 95 phr, no more than about 100 phr, or no more than about 110 phr. In another aspect, the one or more SSBRs can be present in the composition in an amount of from about 75 phr to about 80 phr, from about 75 phr to about 85 phr, from about 75 phr to about 90 phr, from about 75 phr to about 95 phr, from about 75 phr to about 100 phr, from about 75 phr to about 105 phr, from about 75 phr to about 110 phr, or individual values or subranges of the foregoing.

The TPUs can be present in the composition in an amount of from about 5 phr to about 25 phr, from about 10 phr to about 25 phr, from about 15 phr to about 25 phr, from about 20 phr to about 25 phr, from about 10 phr to about 25 phr, from about 10 phr to about 20 phr, from about 10 phr to about 15 phr, from about 5 phr to about 20 phr, from about 5 phr to about 15 phr, from about 5 phr to about 10 phr, or individual values or subranges of the foregoing. In another aspect, the TPUs can be present in an amount of about 5 phr, about 6 phr, about 7 phr, about 8 phr, about 9 phr, about 10 phr, about 11 phr, about 12 phr, about 13 phr, about 14 phr, about 15 phr, about 16, about 17 phr, about 18 phr, about 19 phr, about 20 phr, about 21 phr, about 22 phr, about 23 phr, about 24 phr, or about 25 phr.

The TPUs can comprise a polyester polymer block or derivative thereof. In another aspect, the TPUs can comprise a polyether polymer block or derivative thereof. The one or more TPUs present in the composition can be characterized by various physical or mechanical properties such as density, tensile strength, elongation at break, and/or hardness (i.e., resistance to deformation or indentation). When more than one TPU is present in the composition, the various TPUs can be the same TPU, with the same properties, or a different TPU that varies in at least one physical or mechanical property (e.g., density, tensile strength, elongation at break, and/or hardness).

In one aspect, the rubber composition can comprise one or more TPUs having a density from about 1.00 g/cm³ to about 1.30 g/cm³; from about 1.00 g/cm³ to about 1.25 g/cm³; from about 1.00 g/cm³ to about 1.20 g/cm³; from about 1.00 g/cm³ to about 1.15 g/cm³; from about 1.00 g/cm³ to about 1.10 g/cm³; from about 1.05 g/cm³ to about 1.30 g/cm³; from about 1.05 g/cm³ to about 1.25 g/cm³; from about 1.05 g/cm³ to about 1.20 g/cm³; from about 1.05 g/cm³ to about 1.15 g/cm³; from about 1.05 g/cm³ to about 1.10 g/cm³; from about 1.10 g/cm³ to about 1.30 g/cm³; from about 1.10 g/cm³ to about 1.25 g/cm³; from about 1.10 g/cm³ to about 1.20 g/cm³; or from about 1.10 g/cm³ to about 1.15 g/cm³; or individual values or subranges of the foregoing. For example, in a further aspect, the rubber composition comprises one or more TPU having density of about 1.00 g/cm³, about 1.01 g/cm³, about 1.02 g/cm³, about 1.03 g/cm³, about 1.04 g/cm³, about 1.05 g/cm³, about 1.10 g/cm³, about 1.11 g/cm³, about 1.12 g/cm³, about 1.13 g/cm³, about 1.14 g/cm³, about 1.15 g/cm³, about 1.16 g/cm³, about 1.17 g/cm³, about 1.18 g/cm³, about 1.19 g/cm³, about 1.20 g/cm³, about 1.21 g/cm³, about 1.22 g/cm³, about 1.23 g/cm³, about 1.24 g/cm³, or about 1.25 g/cm³; or ranges comprising one the foregoing as a lower limit and another of the foregoing as an upper limit.

In one aspect, the rubber composition can comprise one or more TPUs having a tensile strength from about 10 MPa to about 50 MPa, from about 10 MPa to about 45 MPa, about 10 MPa to about 40 MPa, about 10 MPa to about 35 MPa, about 10 MPa to about 30 MPa, about 10 MPa to about 25 MPa, about 10 MPa to about 20 MPa, about 10 MPa to about 20 MPa, about 15 MPa to about 50 MPa, from about 15 MPa to about 45 MPa, about 15 MPa to about 40 MPa, about 15 MPa to about 35 MPa, about 15 MPa to about 30 MPa, about 15 MPa to about 25 MPa, about 15 MPa to about 20 MPa, about 20 MPa to about 50 MPa, from about 20 MPa to about 45 MPa, about 20 MPa to about 40 MPa, about 20 MPa to about 35 MPa, about 20 MPa to about 30 MPa, about 20 MPa to about 25 MPa, about 25 MPa to about 50 MPa, from about 25 MPa to about 45 MPa, about 25 MPa to about 40 MPa, about 25 MPa to about 35 MPa, about 25 MPa to about 30 MPa, or individual values or subranges of the foregoing. For example, in a further aspect, the rubber composition can comprise one or more TPUs having a tensile strength of about 10 MPa, about 15 MPa, about 20 MPa, about 25 MPa, about 30 MPa, about 35 MPa, about 40 MPa, about 45 MPa, or about 50 MPa; or ranges comprising one the foregoing as a lower limit and another of the foregoing as an upper limit.

In another aspect, the rubber composition can comprise one or more TPUs having an elongation at break percentage from about 700 percent to about 1200 percent; about 700 percent to about 1100 percent; about 700 percent to about 1000 percent; about 700 percent to about 900 percent; about 700 percent to about 800 percent; about 800 percent to about 1200 percent; about 800 percent to about 1100 percent; about 800 percent to about 1000 percent; about 800 percent to about 900 percent; about 900 percent to about 1200 percent; about 900 percent to about 1100 percent; about 900 percent to about 1000 percent; or individual values or subranges of the foregoing. For example, in a further aspect, the rubber composition comprises one or more TPU having an elongation at break percentage of about 700 percent; about 750 percent; about 800 percent; about 850 percent; about 900 percent; about 950 percent; about 1000 percent; about 1050 percent; about 110 percent; about 1150 percent; or about 1200 percent; or ranges comprising one the foregoing as a lower limit and another of the foregoing as an upper limit.

In another aspect, the rubber composition can comprise one or more TPU having a hardness from about 30 Shore A to about 90 Shore A; about 30 Shore A to about 85 Shore A; from about 30 Shore A to about 80 Shore A; about 30 Shore A to about 75 Shore A; about 30 Shore A to about 70 Shore A; about 30 Shore A to about 65 Shore A; from about 30 Shore A to about 60 Shore A; about 30 Shore A to about 55 Shore A; about 30 Shore A to about 50 Shore A; about 30 Shore A to about 45 Shore A; about 30 Shore A to about 40 Shore A; about 35 Shore A to about 90 Shore A; about 35 Shore A to about 85 Shore A; from about 35 Shore A to about 80 Shore A; about 35 Shore A to about 75 Shore A; about 35 Shore A to about 70 Shore A; about 35 Shore A to about 65 Shore A; from about 35 Shore A to about 60 Shore A; about 35 Shore A to about 55 Shore A; about 35 Shore A to about 50 Shore A; about 35 Shore A to about 45 Shore A; about 35 Shore A to about 40 Shore A; about 40 Shore A to about 90 Shore A; about 40 Shore A to about 85 Shore A; from about 40 Shore A to about 80 Shore A; about 40 Shore A to about 75 Shore A; about 40 Shore A to about 70 Shore A; about 40 Shore A to about 65 Shore A; from about 40 Shore A to about 60 Shore A; about 40 Shore A to about 55 Shore A; about 40 Shore A to about 50 Shore A; or about 40 Shore A to about 45 Shore A; or individual values or subranges of the foregoing. For example, in a further aspect, the rubber composition comprises one or more TPU having a hardness of about 30 Shore A; about 35 Shore A; about 30 Shore A; about 40 Shore A; about 45 Shore A; about 50 Shore A; about 55 Shore A; about 60 Shore A; about 65 Shore A; about 70 Shore A; about 75 Shore A; about 80 Shore A; about 85 Shore A; or about 90 Shore A; or ranges comprising one the foregoing as a lower limit and another of the foregoing as an upper limit.

The compositions disclosed herein can further comprise additional components such as a residual aromatic extract oil and/or a filler. In a further aspect, the filler can comprise carbon black. In a still further aspect, the filler can consist essentially of carbon black. In another aspect, the residual aromatic extract oil can be included in the composition in lieu of other processing oils, such as mineral oils.

In a further aspect, the present disclosure relates to a rubber composition, comprising: one or more TPUs, one or more solution-polymerized styrene butadiene rubbers; and a filler. The filler can be present in an amount of from about 35 phr to about 150 phr; from about 40 phr to about 150 phr; from about 45 phr to about 150 phr; from about 50 phr to about 150 phr; from about 55 phr to about 150 phr; from about 60 phr to about 150 phr; from about 65 phr to about 150 phr; from about 70 phr to about 150 phr; from about 75 phr to about 150 phr; from about 80 phr to about 150 phr; from about 85 phr to about 150 phr; from about 90 phr to about 150 phr; or from about 95 phr to about 150 phr. For example, in a further aspect, the rubber composition can comprise the filler in an amount of about 40 phr, about 45 phr, about 50 phr, about 55 phr, about 60 phr, about 65 phr, about 70 phr, about 75 phr, about 80 phr, about 85 phr, about 90 phr, about 95 phr, about 100 phr, about 105 phr; or ranges comprising one the foregoing as a lower limit and another of the foregoing as an upper limit. In another aspect, the rubber composition can comprise the filler in an amount of at least about 30 phr; at least about 35 phr; at least about 40 phr, at least about 45 phr, at least about 50 phr, at least about 55 phr, at least about 60 phr, at least about 65 phr, at least about 70 phr, at least about 75 phr, at least about 80 phr, at least about 85 phr, at least about 90 phr, or at least about 95 phr.

In another aspect, the present disclosure relates to a rubber composition, comprising: one or more TPUs and a one or more solution-polymerized styrene butadiene rubbers; and further comprising a residual aromatic extract oil. The residual aromatic extract oil can be present in an amount from about 1 phr to about 50 phr; from about 1 phr to about 45 phr; from about 1 phr to about 40 phr; from about 1 phr to about 35 phr; from about 1 phr to about 30 phr; from about 1 phr to about 25 phr; from about 1 phr to about 20 phr; from about 5 phr to about 50 phr; from about 5 phr to about 45 phr; from about 5 phr to about 40 phr; from about 5 phr to about 35 phr; from about 5 phr to about 30 phr; from about 5 phr to about 25 phr; from about 5 phr to about 20 phr; from about 10 phr to about 50 phr; from about 10 phr to about 45 phr; from about 10 phr to about 40 phr; from about 10 phr to about 35 phr; from about 10 phr to about 30 phr; from about 10 phr to about 25 phr; from about 10 phr to about 20 phr; or individual values or subranges of the foregoing. For example, in a further aspect, the rubber composition further comprises the residual aromatic extract oil selected from about 1 phr, about 5 phr, about 10 phr, about 15 phr, about 20 phr, about 25 phr, about 30 phr, about 35 phr, about 40 phr, about 35 phr, about 40 phr, about 45 phr, and about 50 phr; or ranges comprising one the foregoing as a lower limit and another of the foregoing as an upper limit.

The composition can further comprise other commonly used additive materials such as: curing or vulcanizing agents, such as sulfur donors; curing aids, such as activators, accelerators, and retarders; processing additives, such as oils, resins (including tackifying resins or agents), and plasticizers; additional fillers, such as silica; pigments; fatty acids; zinc oxide; waxes; antidegradants, such as antioxidants and antiozonants; and peptizing agents.

Depending on the intended use of the vulcanizable and vulcanized material (rubbers), the additives mentioned above are selected and commonly used in conventional amounts.

Representative antioxidants include, but are not limited to, phenylene diamine compounds (e.g., diphenyl-p-phenylenediamine), hydroquinoline compounds (e.g., anti-polymerized trimethyl dihydroquinoline), amine compounds, dithiocarbamate compounds, phenolic compounds, phosphite compounds, toluimidazole compounds, and others, such as those disclosed in The Vanderbilt Rubber Handbook (1978), Pages 344 through 346.

Representative antiozonants include, but are not limited to, N-phenyl-N′-(1,3-dimethylbutyl)-p-phenylenediamine (6PPD) and N,N′-dixylene-p-phenylenediamine (DTPD). Examples of fatty acids include, but are not limited to, stearic acid, palmitic acids, oleic acid, and mixtures thereof. Microcrystalline waxes, paraffinic waxes, and combinations thereof can be used Accelerators can include, but are not limited to, sulfenamide compounds (e.g., N-cyclohexyl-2-benzothiazolesulfenamide and N-tertbutyl-2-benzothiazolesulfenamide), guanidine compounds (e.g., diphenylguanidine), dithiocarbamate compounds, thiadiazol compounds, thiazole compounds, thiourea compounds, thiuram compound, and xanthate compounds. Retarders can include, but are not limited to, phthalic anhydrides, phthalimides (e.g., N-(cyclohexylthio)phthalimide), sulfenamide compounds, and acids (e.g., benzoic acid and salicylic acid).

### C. Articles

The present disclosure also relates to products or articles comprising the disclosed compositions, wherein the product or the article can be a tire and/or components of tires. More specifically, in one aspect, the disclosure relates to tires comprising the disclosed compositions, wherein the tire is selected from a motorcycle tire; a motorcycle race tire; a motorcycle rear tire; a slick tire; a pneumatic tire; and combinations thereof; a motorcycle tire comprising two fabric reinforced breaker plies radially covered by at least one spirally wound ply strip; a motorcycle tire comprising a split tread comprising two circumferential tread shoulder portions, each comprising the rubber composition, at least a circumferential tread center portion comprising another rubber composition, wherein both rubber compositions are different from each other. In a further aspect, the tire can be free of grooves entirely surrounding the tire in a circumferential direction.

In another aspect, the article comprises a tire, such as a pneumatic tire, or a component of a tire. The tire can be a race tire, passenger tire, aircraft tire, agricultural tire, off-the-road tire, truck or bus tire, and the like. The tire can also be a radial or bias. The component of the tire can be a tread, base, sidewall, apex, chafer, sidewall insert, wirecoat, innerliner, or any combination thereof. In another aspect, the component of the tire including the composition can be a tread, base, sidewall, apex, wirecoat, ply coat, or any combination thereof. Vulcanization of the disclosed tires is generally carried out at conventional temperatures ranging from about 100° C. to about 200° C. or from about 110° C. to about 180° C. Such tires can be built, shaped, molded and cured by various methods which are known and will be readily apparent to those having skill in such art.

In a further aspect, the tire is a motorcycle tire. In a still further aspect, the tire is a motorcycle tire where the motorcycle tire comprises two fabric reinforced breaker plies radially covered by at least one spirally wound ply strip. In a yet further aspect, the tire is a motorcycle tire where the motorcycle tire comprises a split tread comprising two circumferential tread shoulder portions, each comprising the rubber composition, such as a first rubber composition and a second rubber composition; wherein the motorcycle tire comprises a circumferential tread center portion comprising another rubber composition, such as third rubber composition, wherein each of the rubber compositions are different from each other.

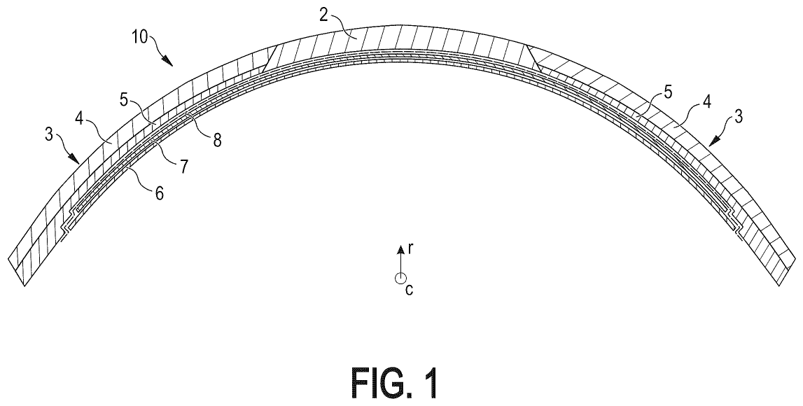

FIG. 1 shows a nonlimiting embodiment of a tire tread 10 supported by reinforcing rubber plies. The tread 10 comprises a tread center portion 2 which is arranged between two outer tread shoulder portions 3. Each tread shoulder portion 3 has a tread cap shoulder portion 4 and a tread base shoulder portion 5 arranged below the tread cap shoulder portion 4. A pair of breaker plies comprises a first breaker ply 6 covered by a second breaker ply 7. Both breaker plies 6, 7 are covered by a radially wound ply strip 8 contacting the tread shoulder portion 3 (particularly the tread base shoulder portion 5) and the tread center portion 2.

In accordance with the present embodiment of the tire tread 10, the tread cap shoulder portions 4 comprise a rubber composition such as one of the experimental compounds detailed in Table 1 and Table 2.

While only the tread cap shoulder portion 4 has in this embodiment the Inventive Example compound in accordance with an embodiment of the present invention, it is also possible that the whole tread or multiple portions of the tread comprise such a rubber compound. In the present embodiment, it is preferred that the tread center portion 2 has a further rubber composition having a higher abrasion resistance than the rubber composition of the tread cap shoulder portion 4. It is also possible, that the tread shoulder portion 3 has only one compound, i.e. without a tread cap/base construction. In the present embodiment, the rubber composition of the tread base shoulder portion 5 is preferably softer than the composition of the tread cap shoulder portion 4, which helps warming up the tire to reach the desired performance as early as possible. However, such a feature is not essential to the present invention which focuses rather on the rubber composition in the cap shoulder area contacting the road when driving, particularly when driving in curves. The shown tread 10 is an example of a rear tire tread of a motorcycle race tire which does not have circumferential grooves. The circumferential direction of the tread 10 and tire is indicated in FIG. 1 by the letter “c”. The radial direction of the tread 10 or tire is indicated by “r”. It extends perpendicularly from the axis of rotation of the tire (not shown). An axial direction, not depicted herein, extends perpendicularly to the radial direction r and the circumferential direction c. The axial direction can also be described as lateral direction. It can also be understood as being in parallel to the axis of the tire.

The ply strip 8 is preferably a spirally wound ply strip 8 which is wound about the breakers 6, 7 with an angle of less than 5° with respect to the circumferential direction of the tire (or, in other words, with respect to the equatorial plane of the tire, which is known to the person skilled in the art). Preferably, such an angle is smaller than 2° or even smaller than 1°. Sometimes reference is also made in this context to a zero-degree ply strip or overlay ply strip.

### D. Preparation of Disclosed Rubber Compositions

The disclosed rubber compositions disclosed herein can be compounded by methods generally known in the rubber compounding art, such as mixing the one or more thermoplastic polyurethanes and the one or more solution-polymerized styrene butadiene rubbers. More particularly, the disclosed compositions disclosed herein can be compounded by methods generally known in the rubber compounding art, such as mixing the one or more thermoplastic polyurethanes and the one or more solution-polymerized styrene butadiene rubbers; wherein the one or more solution-polymerized styrene butadiene rubbers is present in an amount of at least 75 parts per hundred rubber (phr) of one or more solution-polymerized styrene butadiene rubbers. In a further aspect, the disclosed compositions disclosed herein can be compounded by methods generally known in the rubber compounding art, such as mixing the one or more thermoplastic polyurethanes; and the one or more solution-polymerized styrene butadiene rubbers; wherein the one or more TPU is present in an amount an amount of from about 5 phr to about 25 phr; and wherein the one or more solution-polymerized styrene butadiene rubbers is present in an amount of at least 75 parts per hundred rubber (phr) of one or more solution-polymerized styrene butadiene rubbers.

In a further aspect, disclosed rubber compositions disclosed herein can be compounded by methods generally known in the rubber compounding art, such as mixing the one or more thermoplastic polyurethanes; and the one or more solution-polymerized styrene butadiene rubbers; and optionally mixing at least one of a residual aromatic extract oil, a filler, such as carbon black, a resin, an antidegradant, a fatty acid, zinc oxide, a processing aid (e.g., fatty acid soaps), a curing agent, or any combination thereof. The preparation of the disclosed rubber compositions can further comprise optionally mixing one or more additive materials such as: curing or vulcanizing agents, such as sulfur donors; curing aids, such as activators; processing additives, such as oils, resins (including tackifying resins or agents), and plasticizers; fillers, such as carbon black and silica; pigments; zinc oxide; waxes; and antidegradants, such as antioxidants and antiozonants. Depending on the intended use of the vulcanizable and vulcanized material (rubbers), the additives mentioned above are selected and commonly used in conventional amounts and/or the amounts as disclosed herein above.

The compositions disclosed herein can be mixed by methods known in the rubber mixing art. For example, the ingredients can be mixed in at least two stages, namely, at least one nonproductive stage followed by a productive mix stage. In one aspect, the mixing of the uncured composition comprises only a single nonproductive stage. The final curatives including curing or vulcanizing agents may be typically mixed in the final stage, conventionally called the “productive” mix stage. In the productive mix stage, mixing typically occurs at a temperature, or ultimate temperature, lower than the mix temperature(s) of any preceding nonproductive mix stage(s). In one aspect, the mixing stages can comprise thermomechanical mixing, generally characterized by mechanical working in a mixer (e.g., internal batch mixer) or extruder for a period of time at an elevated temperature suitable to produce a rubber. The appropriate duration of the thermomechanical mixing varies as a function of the operating conditions and the volume and nature of the components. For example, the thermomechanical mixing may be from about 0.5 minutes to 10 minutes.

### E. Aspects

The following listing of exemplary aspects supports and is supported by the disclosure provided herein.

Aspect 1. A rubber composition, comprising: a concentration of one or more thermoplastic polyurethanes; and at least 75 parts per hundred rubber (phr) of one or more solution-polymerized styrene butadiene rubbers.

Aspect 2. The rubber composition according to aspect 1, wherein the rubber composition further comprises from about 75 phr to about 150 phr of a filler.

Aspect 3. The rubber composition according to aspect 1 or aspect 2, wherein the rubber composition further comprises from about 1 phr to about 40 phr of a residual aromatic extract oil.

Aspect 4. The rubber composition according to any one of aspects 1-3, wherein the filler comprises at least 40 phr of carbon black.

Aspect 5. The rubber composition according to any one of aspects 1-4, wherein the rubber composition comprises from about 75 phr to about 100 phr of the one or more solution-polymerized styrene butadiene rubbers.

Aspect 6. The rubber composition according to aspect 5, wherein the rubber composition comprises no more than about 95 phr of the one or more solution-polymerized styrene butadiene rubbers.

Aspect 7. The rubber composition according to any one of aspects 1-6, wherein the rubber composition further comprises at least one of a liquid solution-polymerized styrene butadiene rubber, a resin, an antidegradant, a fatty acid, zinc oxide, a processing aid, a curing agent, or any combination thereof.

Aspect 8. The rubber composition according to any one of aspects 1-7, wherein the concentration of the one or more thermoplastic polyurethanes is from about 5 phr to about 25 phr.

Aspect 9. The rubber composition according to aspect 8, wherein the concentration of one or more thermoplastic polyurethanes is from about 10 phr to about 20 phr.

Aspect 10. The rubber composition according to aspect 8, wherein the concentration of one or more thermoplastic polyurethanes is about 15 phr.

Aspect 11. The rubber composition according to any one of aspects 1-10, wherein the one or more thermoplastic polyurethanes comprises a polyester polymer block or derivative thereof.

Aspect 12. The rubber composition according to any one of aspects 1-10, wherein the one or more thermoplastic polyurethanes comprises a polyether polymer block or derivative thereof.

Aspect 13. The rubber composition according to any one of aspects 1-12, wherein the one or more thermoplastic polyurethanes has a density from about 1.00 g/cm³ to about 1.30 g/cm³.

Aspect 14. The rubber composition according to aspect 13, wherein the one or more thermoplastic polyurethanes has a density from about 1.05 g/cm³ to about 1.25 g/cm³.

Aspect 15. The rubber composition according to any one of aspects 1-14, wherein the one or more thermoplastic polyurethanes has a tensile strength from about 10 MPa to about 50 MPa.

Aspect 16. The rubber composition according to any one of aspects 1-15, wherein the one or more thermoplastic polyurethanes has an elongation at break percentage from about 700 percent to about 1200 percent.

Aspect 17. The rubber composition according to any one of aspects 1-16, wherein the one or more thermoplastic polyurethanes has a hardness from about 30 Shore A to about 90 Shore A.

Aspect 18. The rubber composition according to aspect 17, wherein the one or more thermoplastic polyurethanes has a hardness from about 30 Shore A to about 60 Shore A.

Aspect 19. The rubber composition according to any one of aspects 1-18, wherein the rubber composition is cured.

Aspect 20. A tire, comprising the rubber composition of any one of Aspects 1-19.

Aspect 21. The tire according to aspect 20, wherein the tire is one or more of: a motorcycle tire; a motorcycle race tire; a motorcycle rear tire; a slick tire; or a pneumatic tire.

Aspect 22. The tire according to aspect 21, wherein the tire is free of grooves entirely surrounding the tire in a circumferential direction.

Aspect 23. The tire according to aspect 21, wherein the tire is a motorcycle tire.

Aspect 24. The tire according to aspect 23, wherein the motorcycle tire comprises two fabric reinforced breaker plies radially covered by at least one spirally wound ply strip.

Aspect 25. The tire according to aspect 23, wherein the motorcycle tire comprises a split tread comprising two circumferential tread shoulder portions, each comprising the rubber composition, at least a circumferential tread center portion comprising another rubber composition, wherein both rubber compositions are different from each other.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and FIGURES, there is no intent to limit aspects of the present disclosure to this description. On the contrary, the intent is to cover all alternatives, modifications, and equivalents included within the spirit and scope of the present disclosure.

### F. Examples

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Exemplary Rubber Compositions

Six rubber compositions comprising solution-polymerized styrene butadiene rubbers are discussed herein. The rubber compositions comprise three control compositions (A1, B1, and C1) and corresponding experimental compositions (A2, B2, and C2) as outlined in Table 1. Notably, in comparison to their corresponding control compositions, the Experimental compositions all include 15 phr of a TPU in place of 15 phr of SSBR.

TABLE 1
Overview of control compositions (A1, B1, C1), their
corresponding experimental compositions (A2, B2,
C2), and major formulation changes between the two.

| Control | Experimental | Formulation |
|---|---|---|
| Compositions | Composition | Change |
| A1 | A2 | 15 phr TPU in |
| (exemplary hard | | place of SSBR |
| rear composition) | | |
| B1 | B2 | 15 phr TPU in |
| (exemplary medium | | place of SSBR |
| rear composition) | | |
| C1 | C2 | 15 phr TPU in |
| (exemplary soft | | place of SSBR |
| rear composition) | | |

Table 2 provides more detailed formulations for each composition. One notable difference between the control compositions and the experimental compositions (highlighted in Table 1) includes the presence of a TPU in the experimental compositions in place of part of one of the solution-polymerized styrene butadiene rubbers. The SSBRs are oil extended such that the combined total of SSBRs present in each composition is 100 phr, and the remaining amount is an extender oil. For example, for experimental composition A2, 116.68 total phr of the first and second SSBR refers to a total elastomer content of 100 phr and an extender oil content of 16.68 phr.

TABLE 2
Formulations (in phr) for control compositions A1, B1,
and C1 and experimental compositions of A2, B2, and C2.

| | Control Compositions | | | Experimental Compositions | | |
|---|---|---|---|---|---|---|
| Ingredients | A1 | B1 | C1 | A2 | B2 | C2 |
| SSBR¹ | 110.00 | 110.0 | 110.0 | 89.38 | 89.38 | 89.38 |
| SSBR² | 27.50 | 27.50 | 27.50 | 27.50 | 27.50 | 27.50 |
| TPU³ | — | — | — | 15.00 | 15.00 | 15.00 |
| Liquid Polymer⁴ | 45.00 | 7.50 | 7.50 | 45.00 | 7.50 | 7.50 |
| Liquid Polymer⁵ | — | 37.50 | 37.50 | — | 37.50 | 37.50 |
| Carbon Black⁶ | 92.50 | 92.50 | 102.00 | 92.50 | 92.50 | 102.00 |
| Oil⁷ | — | — | 20.00 | 4.00 | 4.00 | 24.00 |
| Resin⁸ | 5.00 | 5.00 | 5.00 | 5.00 | 5.00 | 5.00 |
| Resin⁹ | 5.00 | 5.00 | — | 5.00 | 5.00 | — |
| Antidegradant¹⁰ | 4.00 | 4.00 | 3.92 | 4.00 | 4.00 | 3.92 |
| Processing Aid¹¹ | 2.00 | 2.00 | 2.00 | 2.0 | 2.00 | 2.00 |
| Stearic Acid | 2.62 | 2.62 | 1.31 | 2.62 | 2.62 | 1.31 |
| Zinc Oxide | 2.70 | 2.70 | 4.06 | 2.70 | 2.70 | 4.06 |
| Sulfur | 1.92 | 1.53 | 3.06 | 1.92 | 1.53 | 3.06 |
| Accelerator¹² | 6.00 | 7.50 | 3.50 | 6.00 | 7.50 | 3.50 |
| Accelerator¹³ | 1.00 | 1.43 | — | 1.00 | 1.43 | — |

¹solution-polymerize styrene butadiene rubber having 40% styrene and 39% vinyl and a glass transition temperature (Tg) of −5° C.
²solution-polymerized styrene butadiene rubber having 40% styrene and 14% vinyl and a Tg of −29° C.
³TPU having a hardness of 45 Shore A
⁴liquid styrene butadiene rubbers including at least one rubber having a Tg of −22° C.
⁵liquid styrene butadiene rubbers including at least one rubber having a Tg of −21° C.
⁶carbon black having an iodine adsorption number of 202 g/kg determined by ASTM D1510 or equivalent
⁷RAE oils
⁸alkylphenol resin
⁹coumarone indene resin
¹⁰dihydroquinoline antidegradants and phenylenediamine antidegradants
¹¹fatty acid soaps
¹²N-tert-butylbenzothiazole-2-sulphenamide
¹³tetrabenzylthiuram disulfide

### 2. Exemplary Disclosed Rubber Compositions and Exemplary Properties.

Physical properties and track performance results for the six rubber compositions (A1, B1, C1, A2, B2, and C2) are discussed herein. As seen in Table 3, experimental compositions A2, B2, and C2 showed an increase in hysteresis (indicated by an increased Tan 5 value) and an increase in loss compliance (LC) compared to their respective control compositions A1, B1, and C1. These values were determined using a rubber process analyzer (RPA). This change in hysteresis and LC can be related to the general improvements in grip level and lap time shown in Table 3 for the experimental compositions compared to the control compositions. Additionally, the modulus values for the experimental compositions at 300% elongation (i.e., M300) remain relatively stable compared to their corresponding control compositions: decreasing by no more than 3% for A2 and B2 and increasing for C2. This indicates that wear appearance of tires produced using the experimental composition should be relatively similar to that of tires produced using the control compositions. Overall, the addition of TPU in the experimental compositions produces tires with better balance between wear and dry grip performance.

TABLE 3
Physical properties for control and experimental compositions. Values
for experimental compositions A2, B2, and C2 are normalized compared
to their respective control compositions of A1, B1, and C1.

| Physical | Test | Test | | | | | | |
|---|---|---|---|---|---|---|---|---|
| Property | Temperature | Method | A1 | A2 | B1 | B2 | C1 | C2 |
| Tensile | 23° C. | ASTM | 100 | 83 | 100 | 85 | 100 | 85 |
| Strength | | D412 | | | | | | |
| Elongation at | 23° C. | | 100 | 91 | 100 | 94 | 100 | 87 |
| Break | | | | | | | | |
| M300 | 23° C. | | 100 | 97 | 100 | 97 | 100 | 113 |
| Shore A | 23° C. | ASTM | 100 | 102 | 100 | 102 | 100 | 114 |
| Shore A | 100° C. | D2240 | 100 | 95 | 100 | 98 | 100 | 103 |
| RPA - G* | 100° C. | ASTM | 100 | 86 | 100 | 88 | 100 | 99 |
| (50%) | | D5289 | | | | | | |
| RPA - Tan δ | 100° C. | | 100 | 113 | 100 | 109 | 100 | 121 |
| (50%) | | | | | | | | |
| RPA - LC | 100° C. | | 100 | 131 | 100 | 120 | 100 | 121 |
| (50%) | | | | | | | | |
| Tg | [° C.] | ASTM | 5 | 4 | 6 | 4 | 4 | 2 |
| | | D3418 | | | | | | |

Table 4 shows track evaluation results for the motorcycle tires including the control and experimental compositions. The experimental compositions exhibit similar or better subjective ratings and lap times compared to their corresponding control compostions.

TABLE 4
Track evaluation results for motorcycle tires including control compositions
A1, B1, and C1 and experimental compositions A2, B2, and C2.

| | A1 | A2 | B1 | B2 | C1 | C2 |
|---|---|---|---|---|---|---|
| Entry Stability | 5 | 5 | 5 | 5 | 8 | 8 |
| Entry Grip | 5 | 5 | 5 | 6 | 6 | 8 |
| Mid-Corner Grip | 4 | 5 | 5 | 4 | 5 | 7 |
| Exit Stability | 4 | 5 | 5 | 6 | 7 | 7 |
| Exit Grip | 5 | 5 | 5 | 6 | 6 | 8 |
| Confidence | 4 | 5 | 5 | 5 | 6 | 8 |
| Overall | 4 | 5 | 5 | 6 | 6 | 8 |
| Best Lap Time | 02:08.1 | 02:07.5 | 02:06.5 | 02:05.6 | 02:05.5 | 02:05.4 |

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A rubber composition, comprising:
a concentration of one or more thermoplastic polyurethanes; and
at least 75 parts per hundred rubber (phr) of one or more solution-polymerized styrene butadiene rubbers, wherein the one or more thermoplastic polyurethanes has a hardness from about 30 Shore A to about 60 Shore A.

2. The rubber composition according to claim 1, wherein the rubber composition further comprises from about 75 phr to about 150 phr of a filler.

3. The rubber composition according to claim 2, wherein the filler comprises at least 40 phr of carbon black.

4. The rubber composition according to claim 1, wherein the rubber composition further comprises from about 1 phr to about 40 phr of a residual aromatic extract oil.

5. The rubber composition according to claim 1, wherein the rubber composition comprises from about 75 phr to about 100 phr of the one or more solution-polymerized styrene butadiene rubbers.

6. The rubber composition according to claim 5, wherein the rubber composition comprises no more than about 95 phr of the one or more solution-polymerized styrene butadiene rubbers.

7. The rubber composition according to claim 1, wherein the concentration of the one or more thermoplastic polyurethanes is from about 5 phr to about 25 phr.

8. The rubber composition according to claim 1, wherein the one or more thermoplastic polyurethanes comprises a polyester polymer block or derivative thereof.

9. The rubber composition according to claim 1, wherein the one or more thermoplastic polyurethanes comprises a polyether polymer block or derivative thereof.

10. The rubber composition according to claim 1, wherein the one or more thermoplastic polyurethanes has a hardness from about 30 Shore A to about 90 Shore A.

11. (canceled)

12. The rubber composition according to claim 1, wherein the one or more thermoplastic polyurethanes has a density from about 1.00 g/cm³ to about 1.30 g/cm³.

13. The rubber composition according to claim 1, wherein the one or more thermoplastic polyurethanes has a density from about 1.05 g/cm³ to about 1.25 g/cm³.

14. The rubber composition according to claim 1, wherein the one or more thermoplastic polyurethanes has a tensile strength from about 10 MPa to about 50 MPa.

15. The rubber composition according to claim 1, wherein the one or more thermoplastic polyurethanes has an elongation at break percentage from about 700 percent to about 1200 percent.

16. The rubber composition according to claim 1, wherein the rubber composition further comprises at least one of a liquid solution-polymerized styrene butadiene rubber, a resin, an antidegradant, a fatty acid, zinc oxide, a processing aid, a curing agent, or any combination thereof.

17. The rubber composition according to claim 1, wherein the rubber composition is cured.

18. A tire, comprising the rubber composition of claim 17.

19. The tire according to claim 18, wherein the tire is one or more of:
a motorcycle tire;
a motorcycle race tire;
a motorcycle rear tire;
a slick tire;
a pneumatic tire;
free of grooves entirely surrounding the tire in a circumferential direction;
a motorcycle tire comprising two fabric reinforced breaker plies radially covered by at least one spirally wound ply strip; or
a motorcycle tire comprising a split tread comprising two circumferential tread shoulder portions, each comprising the rubber composition, at least a circumferential tread center portion comprising another rubber composition, wherein both rubber compositions are different from each other.

20. The tire according to claim 18, wherein the tire is a motorcycle tire.
